(19) United States
(12) Patent Application Publication
(10) Pub. No.: US 2017/0161925 A1
(43) Pub. Date: Jun. 8, 2017

(54) Generating a Graphical User Interface From Performance Data

(71) Applicant: CA, Inc., New York, NY (US)

(72) Inventor: Jason Normandin, Marlborough, MA (US)

(21) Appl. No.: 14/956,445

(22) Filed: Dec. 2, 2015

(51) Int. Cl. G06T 11/20; G06F 3/0481; G06F 3/14; H04L 12/24; H04L 12/26

(52) U.S. Cl. CPC G06T 11/206; H04L 41/22; H04L 43/0829; H04L 43/045; G06F 3/14; G06F 3/04817; G06T 2200/24

(57) ABSTRACT

A GUI is generated from received performance data including a first performance metric associated with a first performance warning threshold, and a second performance metric associated with a second performance warning threshold. The GUI includes an x-axis graphically representing a range of available x-values for the first performance metric, and a y-axis graphically representing a range of available y-values for the second performance metric. The y-axis intersects the x-axis at an intersection point (xᵢ, yᵢ). The x- and y-values of the intersection point (xᵢ, yᵢ) correspond to the first and second performance warning thresholds, respectively. The GUI further includes a graphical icon graphically representing a third performance metric positioned at point (x₁, y₁). The x- and y-values of the point (x₁, y₁) respectively correspond to the x- and y-values of the first and second performance metrics at a given time. The GUI is output to a display.

### BACKGROUND

In order to effectively manage a network, administrators commonly require detailed metrics with regard to how that network is performing. Performance metrics such as packet loss, latency, bandwidth, utilization, throughput, mean time between failures, load, capacity, and hop count, for example, may each play a role in the effective administration of a modern network. Such performance metrics are not static, however. Indeed, network conditions often change quite dramatically. For example, user traffic may shift significantly according to need, and hardware failures may cause significant routing problems. Accordingly, mechanisms to efficiently and effectively keep administrators apprised of the present condition of the network are highly valued. In addition, the ability to review historical performance data can provide network administrators with valuable tools for ensuring that their network is up to task for future expansion, for diagnosing previous network failures, and other important network administration tasks.

### BRIEF SUMMARY

Various embodiments of the present disclosure include methods, apparatus, computer program products embodiment on computer-readable storage mediums, and systems of generating a graphical user interface (GUI) from performance data. In an embodiment, a computer-implemented method comprises receiving performance data comprising first and second performance metrics for a communications network. The first performance metric is associated with a first performance warning threshold, and the second performance metric is associated with a second performance warning threshold. The method further comprises generating a GUI from the performance data. The GUI comprises an x-axis graphically representing a range of available x-values for the first performance metric, and a y-axis graphically representing a range of available y-values for the second performance metric. The y-axis intersects the x-axis at an intersection point (xᵢ, yᵢ). The x- and y-values of the intersection point (xᵢ, yᵢ) correspond to the first and second performance warning thresholds, respectively. The GUI further comprises a graphical icon graphically representing a third performance metric and positioned at point (x₁, y₁). The x- and y-values of the point (x₁, y₁) respectively correspond to the x- and y-values of the first and second performance metrics at a given time. The method further comprises outputting the GUI to a display device for display to a user.

In another embodiment, a computing device comprises interface circuitry and processing circuitry. The interface circuitry is configured to exchange signals with a user and a network. The processing circuitry is communicatively coupled to the interface circuitry and is configured to receive performance data comprising first and second performance metrics for a communications network via the interface circuitry. The first performance metric is associated with a first performance warning threshold, and the second performance metric is associated with a second performance warning threshold. The processing circuitry is further configured to generate a graphical user interface (GUI) from the performance data. The GUI comprises an x-axis graphically representing a range of available x-values for the first performance metric, and a y-axis graphically representing a range of available y-values for the second performance metric. The y-axis intersects the x-axis at an intersection point (xᵢ, yᵢ). The x- and y-values of the intersection point (xᵢ, yᵢ) correspond to the first and second performance warning thresholds, respectively. The GUI further comprises a graphical icon graphically representing a third performance metric and positioned at point (x₁, y₁). The x- and y-values of the point (x₁, y₁) respectively correspond to the x- and y-values of the first and second performance metrics at a given time. The processing circuitry is further configured to output the GUI, via the interface circuitry, to a display device for display to the user.

In a further embodiment, a non-transitory computer-readable storage medium comprises computer program code that, when executed by processing circuitry of a programmable computing device, configures the programmable computing device to receive performance data comprising first and second performance metrics for a communications network. The first performance metric is associated with a first performance warning threshold, and the second performance metric is associated with a second performance warning threshold. The computer program code, when executed by the processing circuitry of the programmable computing device further causes the programmable computing device to generate a graphical user interface (GUI) from the performance data. The GUI comprises an x-axis graphically representing a range of available x-values for the first performance metric, and a y-axis graphically representing a range of available y-values for the second performance metric. The y-axis intersects the x-axis at an intersection point (xᵢ, yᵢ). The x- and y-values of the intersection point (xᵢ, yᵢ) correspond to the first and second performance warning thresholds, respectively. The GUI further comprises a graphical icon graphically representing a third performance metric and positioned at point (x₁, y₁). The x- and y-values of the point (x₁, y₁) respectively correspond to the x- and y-values of the first and second performance metrics at a given time. The computer program code, when executed by the processing circuitry of the programmable computing device further causes the programmable computing device to output the GUI to a display device for display to a user.

The embodiments of the present disclosure are not limited to the above contexts or examples, but may include other features and advantages, such as those described in the following detailed description.

### BRIEF DESCRIPTION OF THE DRAWINGS

Aspects of the present disclosure are illustrated by way of example and are not limited by the accompanying figures with like references indicating like elements. In general, the use of a reference numeral should be regarded as referring to the depicted subject matter generally, whereas discussion of a specific instance of an illustrated element will append a letter designation thereto (e.g., discussion of a computing device 110, generally, as opposed to discussion of particular instances of computing devices 110a, 110b, 110c).

FIG. 1 is a block diagram illustrating an example network environment supporting computing devices according to one or more embodiments of the present disclosure.

FIG. 2 is a block diagram illustrating example subnetworks of the example network, according to one or more embodiments of the present disclosure.

FIG. 3 is a table illustrating example performance metrics of the example subnetworks, according to one or more embodiments of the present disclosure.

FIG. 4A is a diagram of an example graphical user interface generated by a computing device according to one or more embodiments of the present disclosure.

FIG. 4B is illustrates a green-to-red color gradient used as a background indicator for the GUI, according to one or more embodiments of the present disclosure.

FIG. 5 is a flow diagram illustrating an example computer-implemented method according to one or more embodiments of the present disclosure.

FIG. 6 is a flow diagram illustrating a more detailed example computer-implemented method according to one or more embodiments of the present disclosure.

FIG. 7 is a block diagram illustrating exemplary hardware configured according to one or more embodiments of the present disclosure.

### DETAILED DESCRIPTION

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

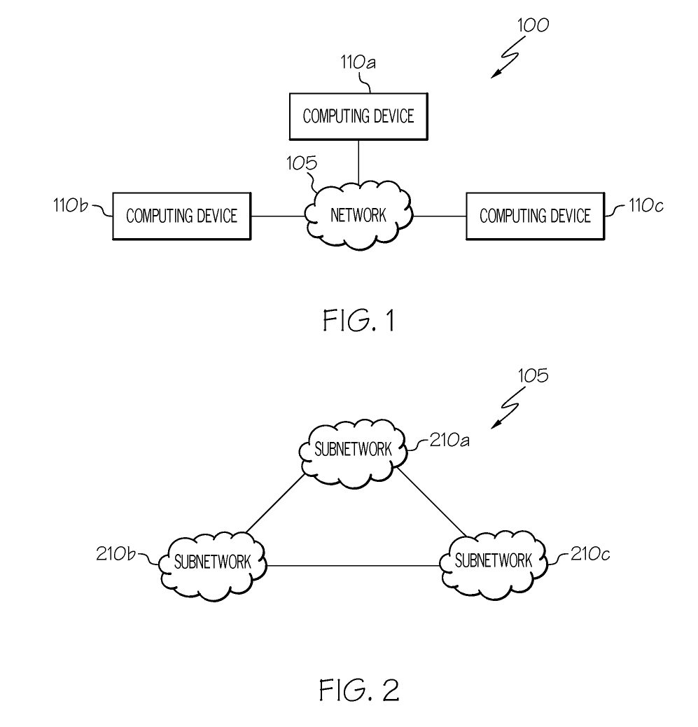

Accordingly, embodiments of the present disclosure generally relate to a computing device that generates a graphical user interface (GUI) for a user from performance data comprising performance metrics for a communications network. FIG. 1 illustrates an example network environment 100 in which just such a computing device 110 may operate. In particular, according to the example illustrated in FIG. 1, the network environment 100 comprises three such computing devices 110a-c and a network 105.

The network 105 may be any network capable of exchanging communication signals with a computing device 110. Examples of the network 105 include (but are not limited to) one or more of the Internet, one or more local area networks, one or more wireless networks, one or more cellular networks, one or more Internet Protocol-based networks, one or more Ethernet networks, one or more optical networks, and one or more circuit switched networks. The network 105 may comprise any number of networking devices including, but not limited to, routers, gateways, switches, hubs, firewalls, and the like (not shown). These networking devices, as well as the computational and networking functions they provide, are resources that are important for operation of the network. These resources may be organized into subnetworks, as will be further discussed below.

The computing devices 110a-c are communicatively connected to the network 105, and may be any computing device that is capable of exchanging signals with the network 105. Examples of a computing device 110 include a personal computer, a laptop computer, a desktop computer, a workstation, a smartphone, a tablet computer, a wearable computer, a server, a server cluster, and a smart appliance.

The computing devices 110a-c receive performance data from the network 105. According to embodiments, a computing device 110 may receive this performance data by communicating with one or more networking devices in the network 105. According to other embodiments, computing devices 110a-c may communicate with each other via the network to share performance data amongst themselves. For example, computing device 110a may poll networking devices in the network via an appropriate protocol (e.g., Simple Network Management Protocol (SNMP)) for the performance data, and distribute the performance data to computing devices 110b, 110c in response to requests therefrom.

Although FIG. 1 illustrates three computing devices 110a-c, other embodiments of the networking environment 100 may include one, two, or more than three computing devices 110. Indeed, a network 105 that is particularly large (e.g., comprising a large number of networking devices) may be divided up into several subnetworks, each of which is a logical partition of the network 105 and may comprise any number of computing devices 110.

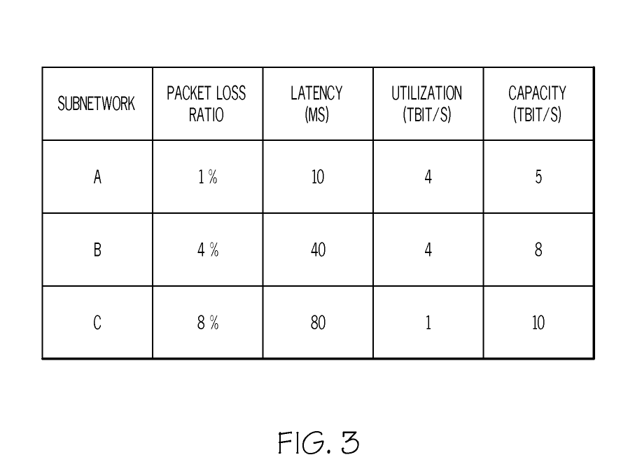

FIG. 2 illustrates an example of network 105 that comprises three subnetworks 210a-c. In the example of FIG. 2, each of the subnetworks 210a-c is communicatively interconnected with every other subnetwork 210. Other embodiments of network 105 may not include subnetworks 210, or may include a different number of subnetworks 210. Further, to the extent that network 105 includes subnetworks 210, these subnetworks may be organized differently than as show in FIG. 2. For example, the subnetworks 210 may be daisy-chained, or organized in a ring configuration. Other configurations are also possible, according to other embodiments.

Each subnetwork 210 may comprise respective resources of the network 105. For example, the subnetworks 210a-c may each correspond to a geographic location in which the resources therein are located. Alternatively, each of the subnetworks 210a-c may correspond to a department of a business to which the resources therein are allocated. The manner in which a subnetwork 210 is defined for a network 105 may vary depending on the needs of the network 105 or the needs of the users therein.

With reference to the examples illustrated in FIGS. 1 and 2, the computing devices 110a-c may be assigned to respective subnetworks 210a-c of network 105. For example, computing device 110a may be assigned to poll resources in subnetwork 210a for performance data pertaining to subnetwork 210a, whereas computing device 110b may be assigned to poll resources in subnetwork 210b for performance data pertaining to subnetwork 210b. Computing device 110c may similarly be assigned to poll resources in subnetwork 210c for performance data pertaining to subnetwork 210c. Further, each of the computing devices 110a-c may periodically communicate with each other to share the performance data pertaining to their respectively assigned subnetworks 210a-c. In this way, the burden of accumulating performance data for the network 105 may be distributed among the computing devices 110a-c. Other organizations of the network 105, involving at least one computing device 110 for receiving the performance data, are possible according to other embodiments.

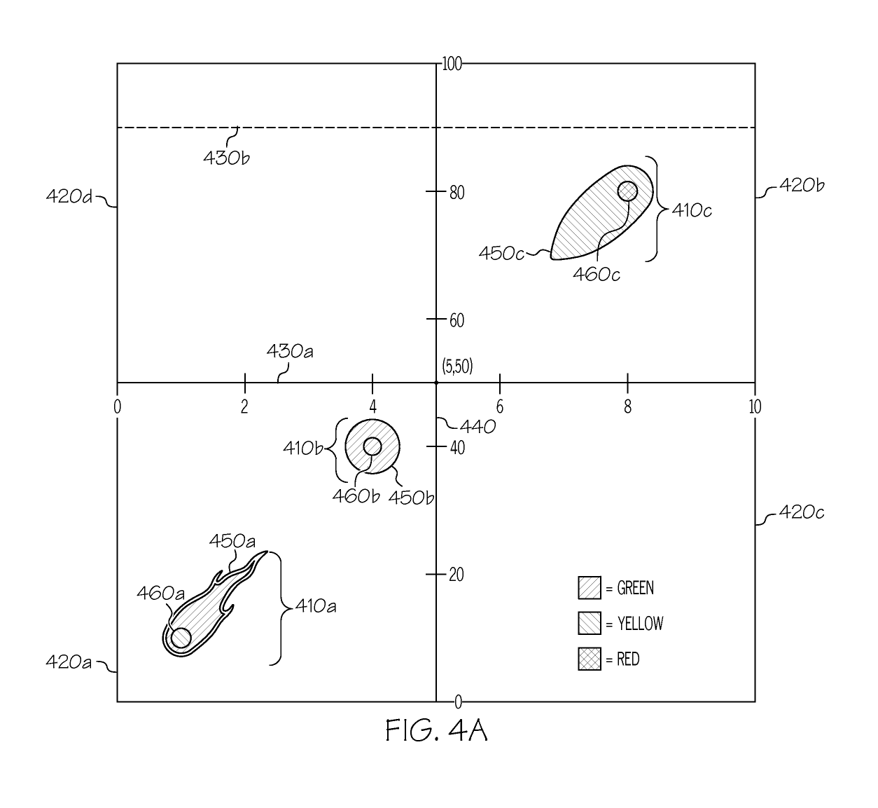

The performance data received by a computing device 110 may comprise a plurality of performance metrics. FIG. 3 illustrates example performance data received by a computing device 110. In particular, the performance data of FIG. 3 comprises four different performance metrics, namely: packet loss ratio, latency (in milliseconds), utilization (in terabits per second), and capacity (in terabits per second). Other examples of performance data may include fewer, additional, or different performance metrics.

The performance data may pertain to certain resources within the network 105 at a particular time. For example, the performance data of FIG. 3 may be a snapshot of the present performance of network 105. Alternatively, the performance data of FIG. 3 may be averages of performance over a particular duration, such as the performance of a network on a particular day. Because network performance may change over time, the computing device 110 may receive performance data such as that depicted in FIG. 3, frequently, periodically, or continually, for example. Consequently, a computing device 110 may, over time, accumulate a performance history for the network 105.

For example, a computing device 110 may receive performance data hourly and save this performance data to a database, along with a timestamp reflecting the time to which the performance data pertains. By reviewing the performance data in the database, a user of the computing device 110 may determine how the network 105 has performed, e.g., throughout the day. The extent to which performance data may be reviewed and analyzed will depend on the frequency and duration for which performance data has been retained by the computing device 110. According to various embodiments, performance data may be available to analyze network performance over days, weeks, months, or even years.

In addition, the computing device 110 may compute additional performance metrics from the received performance data. For example, the computing device 110 may compute a ratio of utilization over capacity. Thus, as applied to the example of FIG. 3, a computing device 110 may determine that subnetwork A, having a utilization of 4 Tbit/s and a capacity of 5 Tbit/s has a utilization/capacity ratio of 80%.

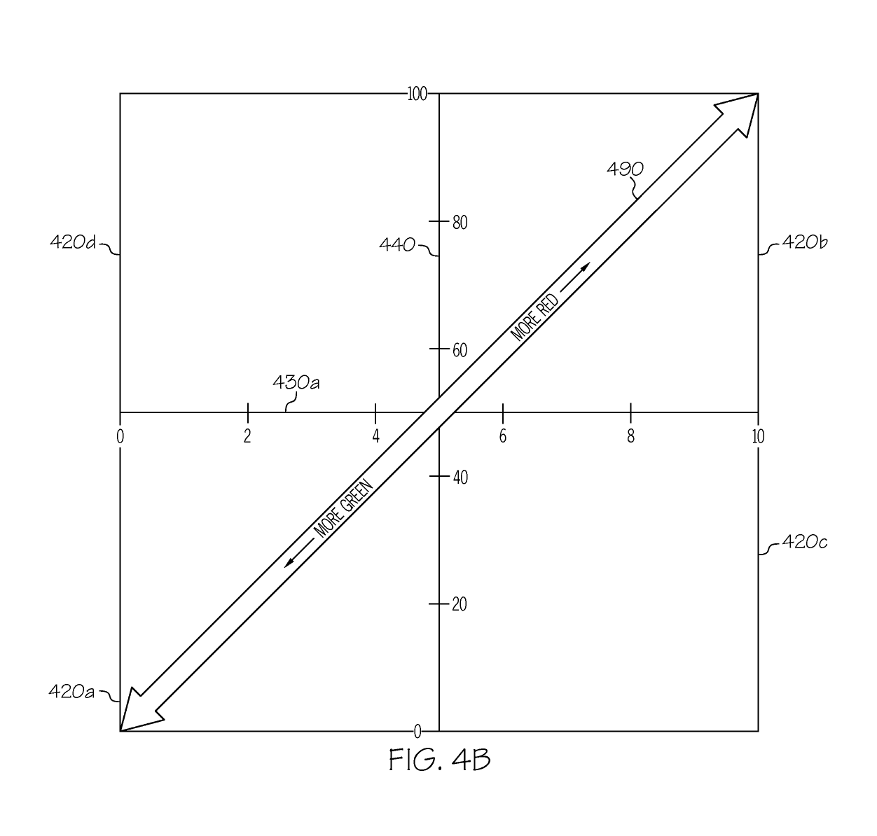

In view of the above, a computing device 110 may accumulate a significant volume of performance data over long periods of time, particularly when the network 105 is highly complex. To facilitate analysis of such performance data by a user of the computing device 110, the computing device generates a GUI from the performance data. An example of such a GUI is illustrated in FIG. 4A.

As shown in FIG. 4A, the GUI comprises a horizontal x-axis 430a, a vertical y-axis 440, and three graphical icons 410a-c. The x-axis 430a graphically represents a range of available x-values for a first performance metric. The y-axis 440 graphically represents a range of available y-values for a second performance metric. The three graphical icons 410a-c are respectively associated with the subnetworks A, B, and C listed in FIG. 3. For each subnetwork 210, a respective graphical icon 410a-c is positioned in the GUI relative to the x-axis 430a and y-axis 440 to indicate the first and second performance metrics for that subnetwork 210 for the same given time.

In this example, the first performance metric is a packet loss metric, as illustrated in FIG. 3 (i.e., a packet loss ratio). The range of available x-values illustrated in FIG. 4A spans zero to ten percent, inclusively. Although a packet loss ratio of 100% is technically possible, in this example, the range of available x-values is tailored to exclude values above ten percent, which are not necessary to graphically represent the packet loss ratios illustrated in FIG. 3. Thus, the computing device 110 may determine the maximum and minimum of a performance metric associated with an axis at the given time, and may generate a GUI such that the axis graphically represents a range bounded by those maximum and minimum values.

The second performance metric in this example is a network latency metric, as illustrated in FIG. 3. The computing device 100 generates the GUI such that at least one network latency metric in the performance data can be represented within the range of y-values. As shown in FIG. 4A, the range of y-values spans zero milliseconds to one-hundred milliseconds, inclusively. Thus, all of the latency metrics illustrated in FIG. 3 may be represented within the range of y-values.

It may be important for a user of the computing device 110 to understand whether the performance metrics in the performance data reflect poor network conditions at a given time. With respect to packet loss ratios and latency times, high values are generally considered less-desirable than low values. To assist the user of the computing device 110 with a more particular understanding of the extent to which present network conditions are acceptable or unacceptable, discrete performance warning thresholds may be associated with respective performance metrics in the performance data. Such performance warning thresholds may be included in the performance data, or may be otherwise configured at the computing device 110 (e.g., by a user). In order to graphically represent the performance warning thresholds that are associated with the performance metrics of the x- and y-axes, the computing device 110 generates the GUI such that the x- and y-axes intersect each other at a particular intersection point (xᵢ, yᵢ).

In this example, the x- and y-values of the intersection point (xᵢ, yᵢ) correspond to the first and second performance warning thresholds, respectively. With particular reference to FIG. 4A, the x- and y-axes intersect at the intersection point (5, 50). Thus, the GUI illustrated in FIG. 4A indicates to the user that a packet loss ratio of 5% is a performance warning threshold for the packet loss metric associated with the x-axis 430a, and that a latency of 50 milliseconds is a performance warning threshold for the latency metric associated with the y-axis 440. Because a high packet loss ratio is generally worse than a low packet loss ratio, x-values on the right side of the y-axis 440 correspond to conditions that exceed the threshold and trigger a warning about packet loss, whereas x-values on the left side of the y-axis 440 correspond to conditions that do not exceed the threshold, and do not trigger a packet loss warning. Similarly, because high latency is generally worse than low latency, y-values above the x-axis 430a correspond to conditions that exceed the threshold and trigger a warning about latency, whereas y-values below the x-axis 430a correspond to conditions that do not exceed the threshold and do not trigger a latency warning.

With further reference to FIG. 4A, the x- and y-axes partition the GUI into four quadrants 420a-d. The first quadrant 420a comprises a plurality of x- and y-values that do not exceed the first and second warning thresholds, respectively. In particular, the first quadrant 420a includes x-values between zero and 5 percent, and y-values between zero and 50 milliseconds.

The second quadrant 420b is diagonally opposed to the first quadrant 420a, and comprises a plurality of x- and y-values that exceed the first and second warning thresholds, respectively. In particular, the second quadrant 420b includes x-values between 5 and 10 percent, and y-values between 50 and 100 milliseconds.

The third quadrant 420c comprises a plurality of x-values that exceed the first warning threshold, and a plurality of y-values that do not exceed the second warning threshold. In particular, the third quadrant 420c includes x-values between 5 and 10 percent, and y-values between zero and 50 milliseconds.

The fourth quadrant 420d comprises a plurality of x-values that do not exceed the first warning threshold, and a plurality of y-values that exceed the second warning threshold. In particular, the fourth quadrant 420d includes x-values between zero and 5 percent, and y-values between 50 and 100 milliseconds.

The above describes an example wherein relatively low x- and y-values are preferable over high x- and y-values. The computing device 110 may graphically represent this using a color gradient as a background indicator within the GUI, as shown in FIG. 4B. For example, the color gradient may comprise a range of position-dependent colors extending from the first quadrant 420a to the second quadrant 420b. As shown in FIG. 4B by the bidirectional color gradient indicator 490, the background color at point (0,0) in the first quadrant 420a may be a deep green, and as positions approach point (10, 100) in the second quadrant 420b, the background may be increasingly-red. As a further example, positions close to the intersection point (5, 50) may be yellow. Although the color gradient exemplified by FIG. 4B extends diagonally from the bottom-left quadrant 420a of the GUI to the top-right quadrant 420b, other embodiments include a color gradient that extends according to a different orientation and/or uses different color representations.

As applied to the example of FIGS. 3 and 4A, graphical icon 410a associated with subnetwork A is positioned at point (1, 10). Graphical icon 410b associated with subnetwork B is positioned at point (4, 40). Graphical icon 410c associated with subnetwork C is positioned at point (8, 80). By virtue of graphical icons 410a, 410b being located in the first quadrant 420a relative to the axes 430a, 440, the GUI reflects that subnetworks A and B are operating within an acceptable packet loss ratio and latency ranges at the given time. However, by virtue of graphical icon 420c being located in the second quadrant 420b relative to the axes 430a, 440, the GUI reflects that subnetwork C is not operating with an acceptable packet loss ratio nor an acceptable latency at the given time.

Although FIG. 4A illustrates two axes that partition the GUI into four quadrants, other embodiments may include one or more additional axes in order to graphically represent further performance warning thresholds. For example, a further x-axis 430b may lie parallel to the x-axis 430a. The further x-axis 430b may intersect the y-axis 440 at a second intersection point (xᵢ, yₐ), wherein the y-value of (xᵢ, yₐ) corresponds to a further second performance warning threshold for the second performance metric.

In the example of FIG. 4A, the second intersection point is positioned at (5, 90), which is above the first intersection point (5, 50). Thus, this second x-axis 430b indicates to the user that a latency of 90 milliseconds is a further performance warning threshold for the latency metric associated with the y-axis 440, (i.e., beyond the aforementioned performance warning threshold at 50 milliseconds). This may, for example, convey to the user that while latency beyond 50 milliseconds is unacceptable, latency beyond 90 milliseconds is a critical condition that must be immediately addressed. The computing device 110 may generate additional or different axes in similar fashion, according to various embodiments.

In addition to understanding whether the performance metrics in the performance data reflect poor network conditions at a given time, it may also be helpful for a user to understand whether network conditions are trending favorably or unfavorably. Thus, the computing device 110 may also generate the GUI to further graphically represent a change metric derived from a change to the first and second performance metrics over time. This change metric may comprise a magnitude (i.e., an extent of the change) and a direction of the change (e.g., whether the change is in the positive and/or negative direction for the first and second performance metrics). This change metric may be calculated by the computing device 110 from the received performance data, or may be comprised in the received performance data itself.

The change metric may be graphically represented in the GUI by a graphical icon 410. In particular, the computing device 110 may generate a shape of a graphical icon 410 to graphically represent the magnitude and direction of the change relative to the axes. The graphical icons 410a-c of FIG. 4A illustrate examples in which magnitude and direction are illustrated by their respective shapes.

Graphical icon 410a has a comet-like outer shape 450a comprising a round leading end and a pointed, elongated trailing end opposing the leading end along a longitudinal axis. The outer shape 450a is much longer than it is wide, which graphically represents that the magnitude of change to the performance metrics of subnetwork A is significant. The orientation of the longitudinal axis and leading end are pointed toward the bottom left of the GUI, which graphically represents that both of the first and second performance metrics for subnetwork A are improving.

The graphical icon 410a also has a circular inner shape 460a with a center positioned at (1, 10), the x- and y-values of which, as previously mentioned, correspond to the first and second performance metrics, respectively, for subnetwork A at the given time. The sizes of the inner and outer shapes, 450a, 460a, also graphically represent performance metrics. Specifically, the size of the inner shape 460b graphically represents the utilization of subnetwork A, whereas the size of the outer shape 460a graphically represents the capacity of subnetwork A. Further, the sizes of the shapes 450a, 460a, relative to each other graphically represent the ratio of utilization over capacity for subnetwork A.

As shown in FIG. 3, subnetwork A has a utilization of 4 Tbit/s and a capacity of 5 Tbit/s. To graphically represent this, the computing device 110 generates the sizes of the inner and outer shapes 460a, 450a such that the inner shape 460a has a radius that is 80% as long as the shortest line segment from the outer shape 450a to the same center point (1, 10). Thus, the sizes of the shapes, relative to each other, graphically represent the utilization/capacity ratio of subnetwork A.

Graphical icon 410a is an example of graphically representing performance metrics for a subnetwork 210 that are relatively volatile. By contrast, graphical icon 410b is an example of graphically representing performance metrics for a subnetwork 210 that are relatively stable. In particular, the outer shape 450b of graphical icon 410b is circular, and lacking the elongated trailing end present in graphical icon 410a. Thus, the outer shape 450b graphically represents that the performance metrics of subnetwork B are not experiencing significant change. According to some embodiments, slight changes may be represented by a slight bulge in outer shape 450.

The scale of the shape sizes used to graphically represent performance metrics within the GUI may be consistent across graphical icons 410, according to embodiments. For example, similarly to graphical icon 410a, the sizes of the inner and outer shapes 460b, 450b of graphical icon 410b depict the utilization and capacity, respectively, of subnetwork B. As shown in FIG. 3, subnetwork B has a utilization of 4 Tbit/s and a capacity of 8 Tbit/s. Thus, the inner shape 460b has a radius that is 50% as long as the shortest line segment from the outer shape 450b to the center point (4, 40). Further, because the utilization of subnetworks A and B are the same (i.e., 4 Tbit/s), the radii length of inner shape 460a and inner shape 460b are the same.

In contrast to graphical icon 410a and graphical icon 410b, which graphically represent performance metrics that are relatively volatile and relatively static, respectively, graphical icon 410c is an example of graphically representing performance metrics for a subnetwork 210 that are changing, but to a lesser degree than those of subnetwork A. In particular, the outer shape 450c of graphical icon 410c is elliptical and has an elongated trailing end similar to the outer shape 450a of graphical icon 410a. However, the elongated trailing end of outer shape 450c is not pointed as in outer shape 450a. Thus, graphical icon 410c conveys to the user a lesser-magnitude of change than that of graphical icon 410c. Notwithstanding, being clearly elongated, graphical icon 410c graphically represents a greater-magnitude of change than that of graphical icon 410b, which is substantially circular.

As shown in FIG. 3, subnetwork C has a utilization of 1 Tbit/s and a capacity of 10 Tbit/s. Thus, the inner shape 460c has a radius that is 10% as long as the shortest line segment from the outer shape 450c to the center point (8, 80). Further, because the utilization of subnetwork C is smaller than that of subnetworks A and B, the radius of inner shape 460c is shorter than that of inner shapes 460a, 460b.

A color of each of the shapes may graphically represent even further performance metrics. For example, in contrast to the shape of outer shape 450, which as discussed above may convey a change metric for the first and second performance metrics (i.e., packet loss ratio and latency) of a subnetwork 210, a color of the inner shape 460 may indicate a rate of change to the utilization of a subnetwork 210, and a color of the outer shape 450 may indicate a rate of change to the capacity of the subnetwork 210.

For example, the colors green, yellow, and red may represent low, medium, and high degrees of change, respectively. With reference to the example of FIG. 4A, graphical icon 410a has an outer shape 450a that has a green color. Thus, the GUI conveys to a user that the capacity of the network is stable. Graphical icon 410a also has an inner shape 460a that has a yellow color. Thus, the GUI conveys to a user that the utilization of subnetwork A is moderately changing.

The ability to graphically depict these numerous performance metrics cohesively within the same GUI conveys a substantial amount of information about a network in a concise manner. For example, the shapes, colors, and positioning of graphical icon 410a, when taken together indicates to a user that a moderate amount of change in utilization within subnetwork A is occurring, such that packet loss and latency within subnetwork A is favorably plummeting in a significant manner. A user could extrapolate that, because the capacity is stable and only slightly above the present utilization, the change in utilization appears to be benefiting the network greatly. This may, for example, confirm for the user that a recent change in the configuration of subnetwork A is having a positive overall effects. Of course, this is only one possible interpretation. The particular embodiments and other attendant circumstances of the user and the network 105 may lead one of ordinary skill to come to other conclusions. Notwithstanding, embodiments of the present disclosure are a power analytical tool for understanding, diagnosing, tracking, and/or evaluating the performance of a network 105, or subnetworks 210 therein.

The GUI depicted in FIG. 4A graphically represents the performance data at a given time, as well as how that performance data has changed as of that given time. However, to convey performance data relevant to a time other than the given time, the computing device 110 may update the GUI. For example, the computing device 110 may receive new or additional performance metrics for the subnetworks 210 represented in the GUI, and in response, reposition the corresponding graphical icons 410 therein. Alternatively, a user of the computing device 110 may request an update of the GUI through an appropriate user input mechanism (e.g., an update button, a time control, a “next” and/or “previous” link).

Further, aspects of the GUI generated by the computing device 110 may be user-customizable. For example, the GUI may allow a user to select a performance metric to associate with one or more of the axes 430, 440. For example, the GUI may accept a right-click mouse input on a particular axis from the user, and display a list of the available performance metrics in the performance data from which the user may make a selection with the left mouse button. In response to receiving this input from the user via the GUI, the computing device 110 may reassign the right-clicked axis to graphically represent a range of axis values that correspond to the user-selected performance metric, and reposition the graphical icons 410 of the GUI accordingly.

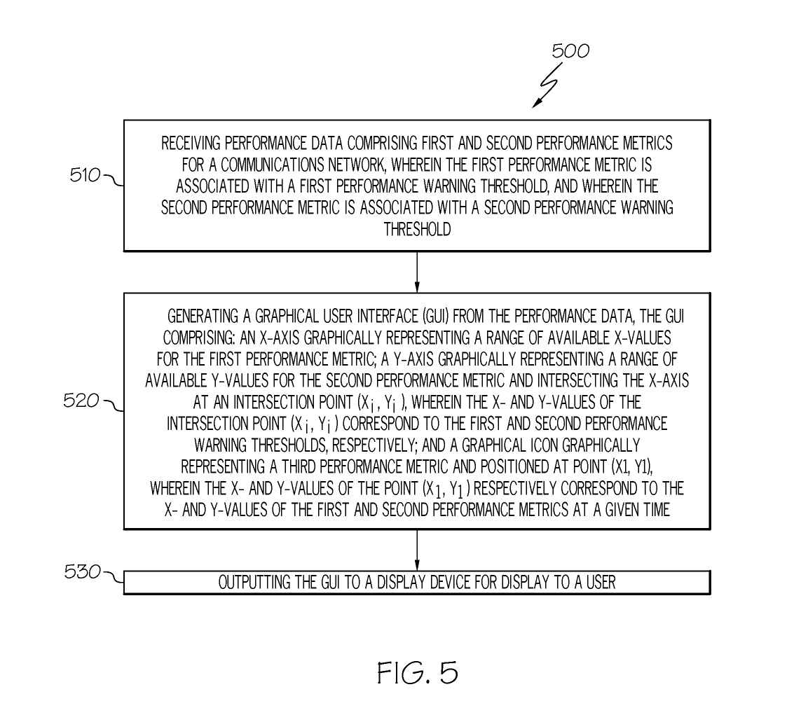

From the discussion above, it is apparent that embodiments of the present disclosure exist according to a variety of computer-implemented methods. An example of such a method 500 is illustrated in FIG. 5. The method 500 comprises receiving performance data comprising first and second performance metrics for a communications network 105 (step 510). The first performance metric is associated with a first performance warning threshold, and the second performance metric is associated with a second performance warning threshold. The method further comprises generating a GUI from the performance data (step 520). The GUI comprises an x-axis 430 graphically representing a range of available x-values for the first performance metric, and a y-axis 440 graphically representing a range of available y-values for the second performance metric. The y-axis 440 intersects the x-axis 430 at an intersection point (xᵢ, yᵢ), wherein the x- and y-values of the intersection point (xᵢ, yᵢ) correspond to the first and second performance warning thresholds, respectively. The GUI further comprises a graphical icon 410 graphically representing a third performance metric and positioned at point (x₁, y₁), wherein the x- and y-values of the point (x₁, y₁) respectively correspond to the x- and y-values of the first and second performance metrics at a given time. The method further comprises outputting the GUI to a display device for display to a user (step 530).

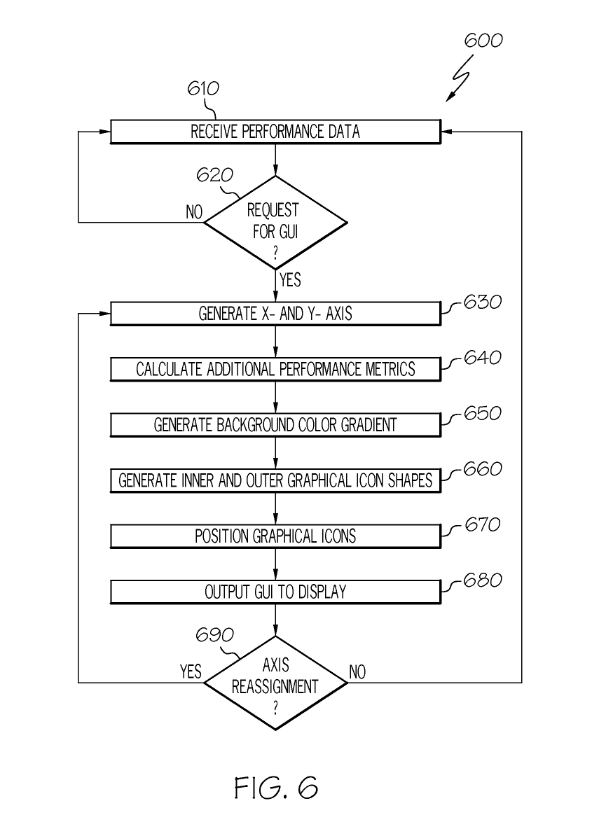

A more detailed example of a computer-implemented method 600, according to embodiments of the present disclosure, is illustrated in FIG. 6. The method 600 comprises receiving performance data (step 610). As previously discussed, the performance data comprises at least first and second performance metrics for a network 105. If no request for a GUI has been received (step 620), the method 600 continues to receive performance data (step 610) until the GUI is requested. Once a request for the GUI is received (step 620), the method 600 comprises generating an x-axis 430 and a y-axis 440, each of which correspond to a performance metric of the performance data, as previously discussed (step 630). The method 600 further comprises calculating additional performance metrics from the received performance data, e.g., by mathematically combining a plurality of the performance metrics in the performance data (step 640). The method 600 further comprises generating a background color gradient (step 650), generating inner and outer graphical icon shapes 460, 450 for one or more graphical icons 410 of the GUI, along with corresponding colors therefor (step 660), and positioning the graphical icons 410 within the GUI relative to the x- and y-axes 430, 440 (step 670). The method further comprises outputting the GUI to a display for a user.

In response to receiving input from a user reassigning an axis (step 690), the method 600 may update the GUI by regenerating the various aspects therein (steps 630, 640, 650, 660, 670, 680, 690). If no input reassigning an axis is received (step 690), the method 600 may receive additional performance data (step 610) until a subsequent request for the GUI is received (step 620), and the method 600, in response, updates the GUI by regenerating the various aspects of the GUI (steps 630, 640, 650, 660, 670) and outputting an updated GUI to the display for the user (step 680).

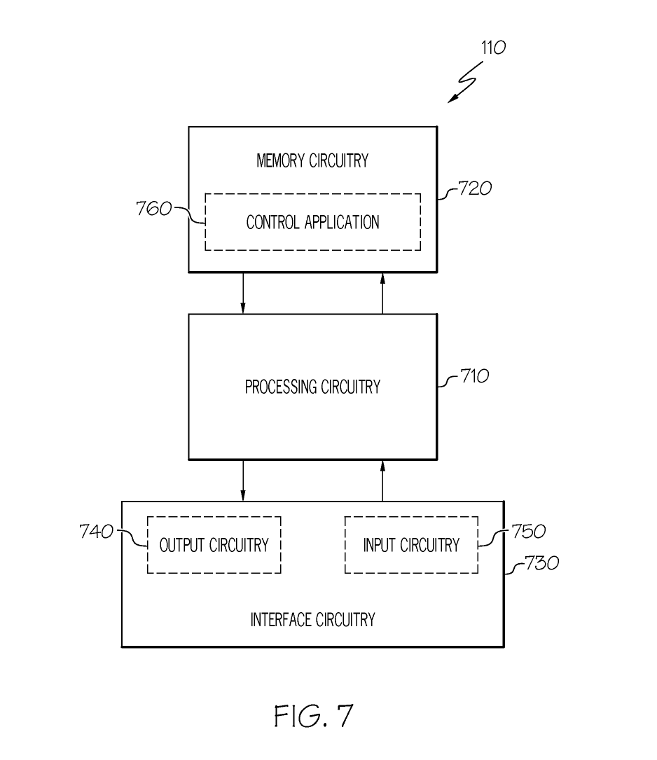

The computing device 110 may be implemented according to the example hardware illustrated in FIG. 7. The example hardware of FIG. 7 comprises processing circuitry 710, memory circuitry 720, and interface circuitry 730. The processing circuitry 710 is communicatively coupled to the memory circuitry 720 and the interface circuitry 730, e.g., via one or more buses. The processing circuitry 710 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 710 may be programmable hardware capable of executing machine instructions stored as a machine-readable computer program 760 in the memory circuitry 720. The memory circuitry 720 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 730 may be a controller hub configured to control the input and output (I/O) data paths of the computing device 110. Such I/O data paths may include data paths for exchanging signals over a communications network 105 and data paths for exchanging signals with a user. For example, the interface circuitry 730 may comprise a transceiver configured to send and receive communication signals over one or more of a cellular network, Ethernet network, or optical network. The interface circuitry 730 may also comprise one or more of a graphics adapter, display port, video bus, touchscreen, graphical processing unit (GPU), display port, Liquid Crystal Display (LCD), and Light Emitting Diode (LED) display, for presenting visual information to a user. The interface circuitry 730 may also comprise one or more of a pointing device (e.g., a mouse, stylus, touchpad, trackball, pointing stick, joystick), touchscreen, microphone for speech input, optical sensor for optical recognition of gestures, and keyboard for text entry.

The interface circuitry 730 may also comprise input circuitry 750 and output circuitry 740. For example, the output circuitry 740 may comprise a transmitter configured to send communication signals over the communications network 105, whereas the input circuitry 750 may comprise a receiver configured to receive communication signals over the communications network 105. Thus, the interface circuitry 730 may be implemented as a unitary physical component, or as a plurality of physical components that may be contiguously or separately arranged, any of which may be communicatively coupled to any other, or may communicate with any other via the processing circuitry 710. Similarly, the output circuitry 740 may comprise a display, whereas the input circuitry 750 may comprise a keyboard. Other examples, permutations, and arrangements of the above and their equivalents will be readily apparent to those of ordinary skill.

The processing circuitry 710 may be configured to receive performance data comprising first and second performance metrics for a communications network 105 via the interface circuitry 730. The first performance metric is associated with a first performance warning threshold, and the second performance metric is associated with a second performance warning threshold. The processing circuitry 710 may be further configured to generate a graphical user interface (GUI) from the performance data. The GUI comprises an x-axis 430 graphically representing a range of available x-values for the first performance metric, and a y-axis 440 graphically representing a range of available y-values for the second performance metric. The y-axis 440 intersects the x-axis 430 at an intersection point (xᵢ, yᵢ), wherein the x- and y-values of the intersection point (xᵢ, yᵢ) correspond to the first and second performance warning thresholds, respectively. The GUI further comprises a graphical icon 410 graphically representing a third performance metric and positioned at point (x₁, y₁), wherein the x- and y-values of the point (x₁, y₁) respectively correspond to the x- and y-values of the first and second performance metrics at a given time. The processing circuitry 710 may be further configured to output the GUI, via the interface circuitry 730, to a display device for display to the user.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A computer-implemented method comprising:
receiving performance data comprising first and second performance metrics for a communications network, wherein the first performance metric is associated with a first performance warning threshold, and wherein the second performance metric is associated with a second performance warning threshold;
generating a graphical user interface (GUI) from the performance data, the GUI comprising:
an x-axis graphically representing a range of available x-values for the first performance metric;
a y-axis graphically representing a range of available y-values for the second performance metric and intersecting the x-axis at an intersection point (xᵢ, yᵢ), wherein the x- and y-values of the intersection point (xᵢ, yᵢ) correspond to the first and second performance warning thresholds, respectively;
a graphical icon graphically representing a third performance metric and positioned at point (x₁, y₁), wherein the x- and y-values of the point (x₁, y₁) respectively correspond to the x- and y-values of the first and second performance metrics at a given time; and
outputting the GUI to a display device for display to a user.

2. The computer-implemented method of claim 1, wherein the x-axis and the y-axis partition the GUI into a plurality of quadrants comprising:
a first quadrant comprising a plurality of x- and y-values that do not exceed the first and second warning thresholds, respectively;
a second quadrant diagonally opposed to the first quadrant, and comprising a plurality of x- and y-values that exceed the first and second warning thresholds, respectively;
a third quadrant comprising a plurality of x-values that exceed the first warning threshold, and a plurality of y-values that do not exceed the second warning threshold; and
a fourth quadrant comprising a plurality of x-values that do not exceed the first warning threshold, and a plurality of y-values that exceed the second warning threshold.

3. The computer-implemented method of claim 2, wherein generating the GUI further comprises generating a color gradient as a background indicator for the GUI, the color gradient comprising a range of position-dependent colors extending from the first quadrant to the second quadrant, and indicating information about a placement of the graphical icon on the GUI with respect to the first, second, third, and fourth quadrants.

4. The computer-implemented method of claim 1, wherein one of the first and second performance metrics is a network latency metric, and wherein the other of the first and second performance metrics is a packet loss metric.

5. The computer-implemented method of claim 1, wherein the third performance metric is a change metric derived from a change to the first and second performance metrics over time, the change metric comprising a magnitude and a direction of the change.

6. The computer-implemented method of claim 5, wherein generating the GUI further comprises generating a shape of the graphical icon, the shape graphically representing, relative to the x- and y-axes, the magnitude and the direction of the change.

7. The computer-implemented method of claim 1, wherein:
the third performance metric is a utilization metric of resources within the network;
generating the GUI further comprises generating an outer shape of the graphical icon surrounding an inner shape of the graphical icon, such that:
a size of the inner shape graphically represents the third performance metric;
a size of the outer shape graphically represents a capacity of the resources;
the sizes of the inner and outer shapes relative to each other graphically represents a ratio of utilization over capacity for the resources.

8. The computer-implemented method of claim 7, wherein:
a color of the inner shape indicates a rate of change to the utilization metric;
a color of the outer shape indicates a rate of change to the capacity of the resources.

9. The computer-implemented method of claim 1, further comprising:
receiving further performance data comprising first and second performance metrics for a further communications network;
wherein generating the GUI from the performance data comprises generating the GUI from the performance data and the further performance data, the GUI further comprising a further graphical icon graphically representing the third performance metric for the further performance data and positioned at point (x₂, y₂), wherein the x- and y-values of the point (x₂, y₂) respectively correspond to the x- and y-values of the first and second performance metrics of the further performance data at the given time.

10. The computer-implemented method of claim 1, further comprising:
updating the GUI, the updating comprising repositioning the graphical icon to point (x₃, y₃), wherein the x- and y-values of the point (x₃, y₃) respectively correspond to the x- and y-values of the first and second performance metrics at a further given time; and
outputting the updated GUI to the display device for display to the user.

11. The computer-implemented method of claim 1, further comprising:
receiving input from the user via the GUI;
updating the GUI, the updating comprising:
reassigning at least one of the x- and y-axes to graphically represent a further range of corresponding axis values for a further performance metric of the performance data according to the input, the further performance metric of the performance data being distinct from the first, second, and third performance metrics; and
repositioning the graphical icon to point (x₄, y₄), wherein the x- and y-values of the point (x₄, y₄) correspond to the x- and y-values, at the given time, of the performance metrics assigned to the x- and y-axes subsequent to the reassigning.

12. A computing device comprising:
interface circuitry configured to exchange signals with a user and a network;
processing circuitry communicatively coupled to the interface circuitry and configured to:
receive performance data comprising first and second performance metrics for a communications network via the interface circuitry, wherein the first performance metric is associated with a first performance warning threshold, and wherein the second performance metric is associated with a second performance warning threshold;
generate a graphical user interface (GUI) from the performance data, the GUI comprising:
an x-axis graphically representing a range of available x-values for the first performance metric;
a y-axis graphically representing a range of available y-values for the second performance metric and intersecting the x-axis at an intersection point (xᵢ, yᵢ), wherein the x- and y-values of the intersection point (xᵢ, yᵢ) correspond to the first and second performance warning thresholds, respectively;
a graphical icon graphically representing a third performance metric and positioned at point (x₁, y₁), wherein the x- and y-values of the point (x₁, y₁) respectively correspond to the x- and y-values of the first and second performance metrics at a given time; and
output the GUI, via the interface circuitry, to a display device for display to the user.

13. The computing device of claim 12, wherein the x-axis and the y-axis partition the GUI into a plurality of quadrants comprising:
a first quadrant comprising a plurality of x- and y-values that do not exceed the first and second warning thresholds, respectively;
a second quadrant diagonally opposed to the first quadrant, and comprising a plurality of x- and y-values that exceed the first and second warning thresholds, respectively;
a third quadrant comprising a plurality of x-values that exceed the first warning threshold, and a plurality of y-values that do not exceed the second warning threshold; and
a fourth quadrant comprising a plurality of x-values that do not exceed the first warning threshold, and a plurality of y-values that exceed the second warning threshold.

14. The computing device of claim 12, wherein to generate the GUI the processing circuitry is further configured to generate a color gradient as a background indicator for the GUI, the color gradient comprising a range of position-dependent colors extending from the first quadrant to the second quadrant, and indicating information about a placement of the graphical icon on the GUI with respect to the first, second, third, and fourth quadrants.

15. The computing device of claim 12, wherein one of the first and second performance metrics is a network latency metric, and wherein the other of the first and second performance metrics is a packet loss metric.

16. The computing device of claim 12, wherein the third performance metric is a change metric derived from a change to the first and second performance metrics over time, the change metric comprising a magnitude and a direction of the change.

17. The computing device of claim 16, wherein to generate the GUI the processing circuitry is further configured to generate a shape of the graphical icon, the shape graphically representing, relative to the x- and y-axes, the magnitude and the direction of the change.

18. The computing device of claim 12, wherein:
the third performance metric is a utilization metric of resources within the network;
to generate the GUI the processing circuitry is further configured to generate an outer shape of the graphical icon surrounding an inner shape of the graphical icon, such that:
a size of the inner shape graphically represents the third performance metric;
a size of the outer shape graphically represents a capacity of the resources;
the sizes of the inner and outer shapes relative to each other graphically represents a ratio of utilization over capacity for the resources.

19. The computing device of claim 18, wherein:
a color of the inner shape indicates a rate of change to the utilization metric;
a color of the outer shape indicates a rate of change to the capacity of the resources.

20. The computing device of claim 12, wherein:
the processing circuitry is further configured to receive further performance data comprising first and second performance metrics for a further communications network via the interface circuitry;
to generate the GUI from the performance data the processing circuitry is further configured to generate the GUI from the performance data and the further performance data, the GUI further comprising a further graphical icon graphically representing the third performance metric for the further performance data and positioned at point (x₂, y₂), wherein the x- and y-values of the point (x₂, y₂) respectively correspond to the x- and y-values of the first and second performance metrics of the further performance data at the given time.

21. The computing device method of claim 12, wherein the processing circuitry is further configured to:
update the GUI, the updating comprising repositioning the graphical icon to point (x₃, y₃), wherein the x- and y-values of the point (x₃, y₃) respectively correspond to the x- and y-values of the first and second performance metrics at a further given time; and
output the updated GUI, via the interface circuitry, to the display device for display to the user.

22. The computing device of claim 12, wherein the processing circuitry is further configured to:
receive input from the user via the GUI;
update the GUI, the updating comprising:
reassigning at least one of the x- and y-axes to graphically represent a further range of corresponding axis values for a further performance metric of the performance data according to the input, the further performance metric of the performance data being distinct from the first, second, and third performance metrics; and
repositioning the graphical icon to point (x₄, y₄), wherein the x- and y-values of the point (x₄, y₄) correspond to the x- and y-values, at the given time, of the performance metrics assigned to the x- and y-axes subsequent to the reassigning.

23. A non-transitory computer-readable storage medium comprising computer program code that, when executed by processing circuitry of a programmable computing device, configures the programmable computing device to:
receive performance data comprising first and second performance metrics for a communications network, wherein the first performance metric is associated with a first performance warning threshold, and wherein the second performance metric is associated with a second performance warning threshold;
generate a graphical user interface (GUI) from the performance data, the GUI comprising:
an x-axis graphically representing a range of available x-values for the first performance metric;
a y-axis graphically representing a range of available y-values for the second performance metric and intersecting the x-axis at an intersection point (xᵢ, yᵢ), wherein the x- and y-values of the intersection point (xᵢ, yᵢ) correspond to the first and second performance warning thresholds, respectively;
a graphical icon graphically representing a third performance metric and positioned at point (x₁, y₁), wherein the x- and y-values of the point (x₁, y₁) respectively correspond to the x- and y-values of the first and second performance metrics at a given time; and
output the GUI to a display device for display to a user.
